(19) United States
(12) Patent Application Publication
(10) Pub. No.: US 2026/0038714 A1
(43) Pub. Date: Feb. 5, 2026

(54) SEMICONDUCTIVE TAPES FOR CABLES AND METHODS FOR THE SAME

(71) Applicant: Neenah, Inc., Alpharetta, GA (US)

(72) Inventors: Geoffrey Henstock, Greater Manchester (GB); Celia Drysdale, Salford (GB)

(21) Appl. No.: 19/287,318

(22) Filed: Jul. 31, 2025

Related U.S. Application Data
(60) Provisional application No. 63/678,690, filed on Aug. 2, 2024.

(51) Int. Cl. H01B 9/02; C09D 5/18; C09D 5/24; C09D 7/43; C09D 7/61; C09D 7/65; C09D 133/04; C09D 181/06; D04H 1/435; D04H 1/558; D06N 3/00; D06N 3/04; D06N 3/18

(52) U.S. Cl. CPC H01B 9/027; C09D 5/18; C09D 5/24; C09D 7/43; C09D 7/61; C09D 7/65; C09D 133/04; C09D 181/06; D04H 1/435; D04H 1/558; D06N 3/0011; D06N 3/0036; D06N 3/0063; D06N 3/042; D06N 3/186; D06N 2201/02; D06N 2203/041; D06N 2211/00; D10B 2401/063; D10B 2401/10; D10B 2505/00

(57) ABSTRACT

A semiconducting tape for a power or signal carrying cable or a conductor assembly thereof is described herein. The semiconducting tape may include a nonwoven sheet and a semiconductive composition disposed on the nonwoven sheet. The semiconductive composition may include a resin or a polymer and a conductive material disposed in the resin or the polymer. The nonwoven sheet may include a first plurality of fibers and a second plurality of fibers, wherein the first plurality of fibers is different than the second plurality of fibers. The semiconducting tape may have a penetration resistance of less than 5% or a penetration resistance of about 400 Newtons (N) or greater.

### CROSS-REFERENCE TO RELATED APPLICATIONS

This application claims the benefit of U.S. provisional application No. 63/678,690 filed Aug. 2, 2024, the complete disclosure of which is incorporated herein by reference for all purposes.

### TECHNICAL FIELD

The following description generally relates to tapes or wraps used in the manufacture of cables, such as optical and power cables; particularly, semiconductive tapes that provide a semiconductive and/or mechanical layer or barrier for the cables.

### BACKGROUND

Tapes and wraps are often utilized in the manufacture of power and signal carrying cables to provide a chemical, mechanical, and/or electrical barrier between layers thereof. For example, power cables often utilize tapes to form an insulation shield around fibrous insulating layers to prevent fibers thereof from infiltrating and damaging other layers of the power cables. Currently, tapes for preparing insulating shields mainly utilize woven sheets, which exhibit relatively lower permeability and greater tensile strength as compared to nonwoven sheets prepared from long and/or short fibers. In some instances, the woven sheets of the conventional tapes may be treated with a binder (e.g., polymeric binder, semiconductive polymeric binder, etc.) to further reduce the permeability thereof. It would be desirable, however, to provide comparable or improved tapes and wraps that include or utilize nonwoven sheets, which are relatively more cost effective.

### BRIEF SUMMARY

This following is intended merely to introduce a simplified summary of some aspects of one or more implementations of the subject matter discussed herein. Further areas of applicability of the subject matter will become apparent from the detailed description provided hereinafter. This summary is not an extensive overview, nor is it intended to identify key or critical elements of the present teachings, nor to delineate the scope of the subject matter. Rather, its purpose is merely to present one or more concepts in simplified form as a prelude to the detailed description below.

The foregoing and/or other aspects and utilities described herein may be achieved by providing a semiconducting tape for cables. The semiconducting tape can include a nonwoven sheet and a semiconductive composition disposed on the nonwoven sheet. The semiconductive composition may include a resin or a polymer and a conductive material disposed in the resin or the polymer.

In one aspect, the resin or the polymer may include one or more of a polypropylene-based resin, a polyethylene-based resin, a copolymer of an olefin, a polyester, a polycarbonate, an acrylic polymer, an acrylate polymer, a polyacrylate, a phenol resin, a urea resin, a copolymer thereof, or any combination thereof.

In one aspect, the resin or the polymer may include one or more of an acrylate, an acrylic polymer, an acrylate polymer, a polyacrylate, polyethylene (PE), low density PE (LDPE), medium density PE (MDPE), high density PE (HDPE), linear low density PE (LLDPE), ultra-low density polyethylene (ULDPE), polypropylene (PP), elastomeric ethylene/propylene copolymers (EPR), ethylene/propylene/diene terpolymers (EPDM), natural rubber, butyl rubber, ethylene/vinyl acetate (EVA), ethylene/methyl acrylate (EMA), ethylene/ethyl acrylate (EEA), ethylene/butyl acrylate (EBA), ethylene/alpha-olefin thermoplastic copolymers, polystyrene, acrylonitrile/butadiene/styrene (ABS) resins, polyvinyl chloride (PVC), polyurethane (PUR), polyamides, polyethylene terephthalate (PET), polybutylene terephthalate (PBT), a copolymer thereof, or any combination thereof.

In one aspect, the base resin or polymer may be water-based or in the form of an aqueous dispersion. For example, the base resin or polymer may be or include an aqueous dispersion of an acrylic polymer and/or an acrylic copolymer. The acrylic polymer and/or acrylic copolymer may include a self-crosslinking acrylic copolymer dispersion. The self-crosslinking acrylic copolymer dispersion may be surfactant stabilized. The self-crosslinking acrylic copolymer dispersion may have fine particle sizes. The self-crosslinking acrylic copolymer aqueous dispersion may have a solid content of about 45%, a pH of about 4.0, a viscosity at 25° C. of less than 100 mPas, and/or a glass transition temperature (DSC) (Tg) of about −30° C.

In one aspect, the conductive material may include metallic conductive particles, carbon black, graphite, graphene, carbon nanotubes, or any combination thereof.

In one aspect, the conductive material may include carbon black.

In one aspect, the semiconductive composition may further include a crosslinking agent.

The foregoing and/or other aspects and utilities described herein may be achieved by providing a semiconducting tape including a nonwoven sheet and a semiconductive composition disposed on the nonwoven sheet. The nonwoven sheet may include a first plurality of fibers and a second plurality of fibers, wherein the first plurality of fibers is different than the second plurality of fibers.

In one aspect, the melting point or the glass transition temperature of the second plurality of fibers may be relatively lower than the melting point or the glass transition temperature of the first plurality of fibers.

In one aspect, the nonwoven sheet may include the first plurality of fibers and the second plurality of fibers heated and pressed into a single layer.

In one aspect, the first plurality of fibers and the second plurality of fibers may include polyester fibers having an average single fiber fineness of from about 0.5 decitex (dtex) to about 9 dtex.

In one aspect, a weight ratio of the first plurality of fibers to the second plurality of fibers is from about 1:5 to about 5:1.

The foregoing and/or other aspects and utilities described herein may be achieved by providing a semiconducting tape including a nonwoven sheet and a semiconductive composition disposed on the nonwoven sheet. The semiconducting tape may have a penetration resistance, of less than 10%, less than 5%, less than 4%, less than 3%, less than 2%, or less than 1%. The semiconducting tape may also have a penetration resistance of about 10% or less, about 5% or less, about 4% or less, about 3% or less, about 2% or less, or about 1% or less, as compared to a conventional semiconducting tape prepared from a woven sheet. The semiconducting tape may also have a penetration resistance of about 200 N or greater, about 300 N or greater, about 400 N or greater, about 500 N or greater, about 600 N or greater, about 700 N or greater, about 800 N or greater, or about 900 N or greater.

In one aspect, the nonwoven sheet may include an air permeability, according to ASTM D737, of from about 0.5 cc/cm²/sec to about 7 cc/cm²/sec.

In one aspect, the nonwoven sheet may include an average pore size of from about 5 μm to about 16 μm.

In one aspect, the nonwoven sheet may have one or more of the following: a weight, according to ISO 536 standards, of from about 50 g/m² to about 100 g/m²; a thickness, according to ISO 534 standards, of from about 50 μm to about 150 μm, about 80 μm to about 120 μm, or about 60 μm to about 80 μm; a tensile strength, according to WSP 110.4, of mini 8 200 cN/15 mm or mini 3 600 cN/15 mm; a breaking strength true warp, as measured according to ASTM D1000, of from about 30 N/cm to about 90 N/cm or greater; an elongation true warp, as measured according to ASTM D1000, of from about 5% to about 40%; a breaking strength weft, as measured according to ASTM D1000, of from about 15 N/cm to about 50 N/cm; and/or an elongation weft, as measured according to ASTM D1000, of from about 5% to about 40%.

In one aspect, the nonwoven sheet may further include a casting solution disposed on a portion thereof. The casting solution may include a polysulfone.

In one aspect, the semiconducting tape may further include a flame retardant material.

In one aspect, the semiconducting tape may have a resistance of from about 1 ohm to about 30 ohm, or about 75 ohm to about 175 ohm.

In one aspect, the semiconducting tape may include a volume resistivity of from about 0.01 ohm-meter to about 0.5 ohm-meter, or about 1 ohm-cm to about 100 ohm-cm.

In one aspect, the semiconductive composition may include a thickener. The thickener may include an anionic aqueous solution of a synthetic polyacrylate. The thickener may be ammonia free. The thickener may include a total solids content of from about 9% to about 13%.

The foregoing and/or other aspects and utilities described herein may be achieved by providing a conductor assembly, including a conductor core, an insulation layer disposed radially outward of the conductor core, an outer sheath disposed radially outward of the insulation layer, and any one or more of the foregoing semiconducting tapes and/or the semiconducting tapes described below. The semiconducting tape may be disposed about the conductor core, the insulation layer, or a combination thereof.

Further areas of applicability of the subject matter will become apparent from the detailed description provided hereinafter. It should be understood that the detailed description and specific examples, while indicating some typical aspects of the subject matter, are intended for purposes of illustration only and are not intended to limit the scope thereof.

The recitation herein of desirable objects which may be met by various embodiments of the present description is not meant to imply or suggest that any or all of these objects may be present as essential features, either individually or collectively, in the most general embodiment of the present description or any of its more specific embodiments.

### BRIEF DESCRIPTION OF THE DRAWINGS

The accompanying drawings, which are incorporated in and constitute a part of this specification, illustrate several embodiments of the subject matter and, together with the description, serve to explain the principles thereof.

FIG. 1 illustrates a schematic view of an exemplary power cable, according to one or more implementations discussed herein.

### DETAILED DESCRIPTION

This description and the accompanying drawings illustrate exemplary embodiments and should not be taken as limiting, with the claims defining the scope of the present description, including equivalents. Various mechanical, compositional, structural, and operational changes may be made without departing from the scope of this description and the claims, including equivalents. In some instances, well-known structures and techniques have not been shown or described in detail so as not to obscure the description. Like numbers in two or more figures represent the same or similar elements. Furthermore, elements and their associated aspects that are described in detail with reference to one embodiment may, whenever practical, be included in other embodiments in which they are not specifically shown or described. For example, if an element is described in detail with reference to one embodiment and is not described with reference to a second embodiment, the element may nevertheless be claimed as included in the second embodiment. Moreover, the depictions herein are for illustrative purposes only and do not necessarily reflect the actual shape, size, or dimensions of the system or illustrated components.

It is noted that, as used in this specification and the appended claims, the singular forms “a,” “an,” and “the,” and any singular use of any word, include plural referents unless expressly and unequivocally limited to one referent. As used herein, the term “include” and its grammatical variants are intended to be non-limiting, such that recitation of items in a list is not to the exclusion of other like items that can be substituted or added to the listed items.

Except as otherwise noted, any quantitative values are approximate whether the word “about” or “approximately” or the like are stated or not. The materials, methods, and examples described herein are illustrative only and not intended to be limiting.

As used throughout, ranges are used as shorthand for describing each and every value that is within the range. It should be appreciated and understood that the description in a range format is merely for convenience and brevity and should not be construed as an inflexible limitation on the scope of any embodiments or implementations discussed herein. Accordingly, the range should be construed to have specifically disclosed all the possible subranges as well as individual numerical values within that range. As such, any value within the range may be selected as the terminus of the range. For example, description of a range such as from 1 to 5 should be considered to have specifically disclosed subranges such as from 1.5 to 3, from 1 to 4.5, from 2 to 5, from 3.1 to 5, etc., as well as individual numbers within that range, for example, 1, 2, 3, 3.2, 4, 5, etc. This applies regardless of the breadth of the range.

Additionally, all numerical values are “about” or “approximately” the indicated value, and take into account experimental error and variations that would be expected by a person having ordinary skill in the art. It should be appreciated that all numerical values and ranges discussed herein are approximate values and ranges, whether “about” is used in conjunction therewith. It should also be appreciated that the term “about,” as used herein, in conjunction with a numeral refers to a value that may be ±0.01% (inclusive), ±0.1% (inclusive), ±0.5% (inclusive), ±1% (inclusive) of that numeral, ±2% (inclusive) of that numeral, ±3% (inclusive) of that numeral, ±5% (inclusive) of that numeral, ±10% (inclusive) of that numeral, or ±15% (inclusive) of that numeral. It should further be appreciated that when a numerical range is discussed herein, any numerical value falling within the range is also specifically disclosed.

As used herein, “free” or “substantially free” of a material may refer to a composition, component, or phase where the material is present in an amount of less than 10.0 wt %, less than 5.0 wt %, less than 3.0 wt %, less than 1.0 wt %, less than 0.1 wt %, less than 0.05 wt %, less than 0.01 wt %, less than 0.005 wt %, or less than 0.0001 wt % based on a total weight of the composition, component, or phase.

All references cited herein are hereby incorporated by reference in their entireties. In the event of a conflict in a definition with a cited reference, the present teachings control.

The present inventors have surprisingly and unexpectedly discovered that nonwoven sheets treated or otherwise contacted with a semiconductive composition exhibited significantly increased penetration resistance as compared to woven sheets contacted with the semiconductive composition.

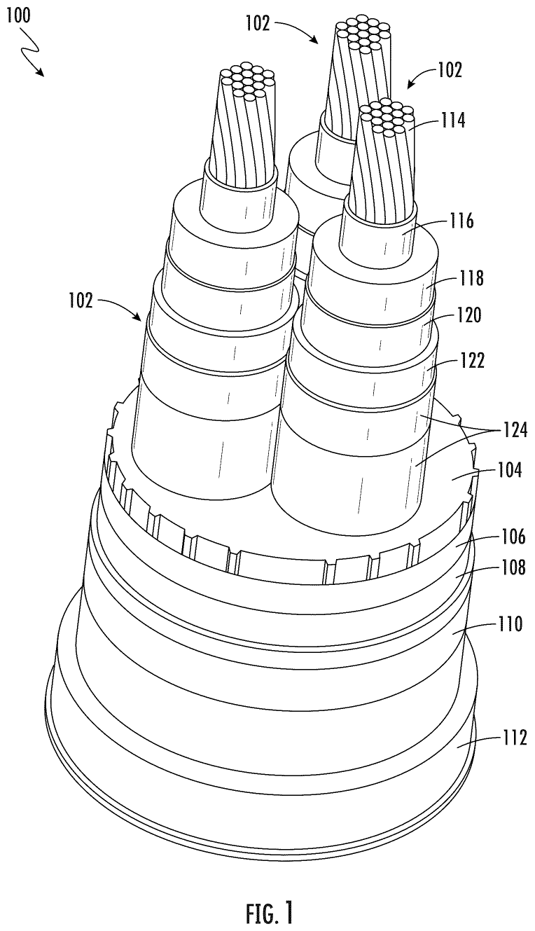

FIG. 1 illustrates a schematic view of an exemplary power cable 100, according to one or more implementations. The power cable 100 may include one or more conductor assemblies 102 (e.g., three are shown in FIG. 1), a cable jacket 104, one or more layers of a binder tape 106, one or more inner sheaths or coverings 108, one or more layers of armor 110 (e.g., metal armor), an outer sheath or covering 112, or any combination thereof. For example, as illustrated in FIG. 1, the power cable 100 may include three conductor assemblies 102 seated or otherwise disposed in a cable jacket 104, a layer of a binder tape 106 disposed about the cable jacket 104, an inner sheath 108 disposed about the binder tape 106, a layer of armor 110 disposed about the inner sheath 108, and an outer sheath 112 disposed about the layer of armor 110. It should be appreciated that the power cable 100 may exclude any one or more of the foregoing components. For example, the power cable 100 may exclude the binder tape 106, the inner sheath 108, or any combination thereof. The cable jacket 104 may be or include a filler material, such as a polymeric filler material, capable of or configured to fill a void in the power cable 100. The binder tape 106 may be capable of or configured to at least partially reinforce the power cable 100 and/or a component thereof. The inner sheath 108 may be capable of or configured to provide a barrier to separate two or more components of the power cable 100. The inner sheath 108 may also be capable of or configured to provide a base, bed, or substrate for the layer of armor 110. The layer of armor 110 may be capable of or configured to reinforce the power cable 100. The outer sheath 112 may be capable of or configured to encase or provide a barrier for the power cable 100 to protect the components thereof from the environment (e.g., subsea environment).

It should be appreciated that each of the conductor assemblies 102 discussed herein may include similar components and parts. Consequently, discussions regarding a single conductor assembly 102 are equally applicable to the remaining conductor assemblies 102. The conductor assembly 102 may include a conductor core 114, one or more conductor shields 116, one or more insulation layers 118, one or more insulation shields or screens 120, one or more metallic shields or screens 122, one or more barrier layers 124, or any combination thereof. For example, as illustrated in FIG. 1, the conductor assembly 102 may include a conductor core 114, a conductor shield 116 disposed about the conductor core 114, an insulation layer 118 disposed about the conductor shield 116, an insulation shield or screen 120 disposed about the insulation layer 118, a metallic shield or screen 122 disposed about the insulation shield 120, and two barrier layers 124 disposed about the metallic shield 122.

In at least one implementation, a semiconducting cable tape or wrap, as described herein, may be used as a replacement/substitution for one or more components of the conductor assembly 102. The semiconducting cable tape describe herein may also be used in addition to one or more components of the conductor assembly 102. For example, the exemplary semiconducting cable tape (“tape”) may be used for or in the preparation of the conductor shield 116, the insulation shield or screen 120, one or more of the barrier layers 124, or any combination thereof. In an exemplary implementation, the tape may be used for the conductor shield 116, the insulation shield 120, or a combination thereof. In another example, the semiconducting cable tape may be used in addition to or in conjunction with a conventional conductor shield 116, a conventional insulation shield 120, a conventional barrier layer 124, or any combination thereof. In at least one implementation, the insulation layer 118 may be or include a plurality of fibers, and the semiconducting cable tape may be disposed about the insulation layer 118 to form the insulation shield 120 and thereby prevent or resist the penetration of the fibers from the insulation layer 118 therethrough. In at least one implementation, the semiconducting cable tape may be disposed about the conductor core 114 to form the conductor shield 116 to thereby provide a semiconducting barrier between the conductor core 114 and the remaining components of the conductor assembly 102.

The semiconducting cable tape (“tape”) may include one or more nonwoven sheets, a semiconductive composition, or a combination thereof. For example, the tape may include a nonwoven sheet prepared from a plurality of fibers, and a semiconductive composition disposed in, on, and/or about at least a portion of the nonwoven sheet and/or the plurality of fibers thereof. The semiconductive composition may be disposed on a first side or face of the nonwoven sheet, a second side or face of the nonwoven sheet, or on both opposing sides or faces of the nonwoven sheet.

The semi-conducting cable tape may be in the form of a sheet, a strip, a roll, a film, a textile, or the like. For example, the tape may be prepared as a sheet capable of or configured to form a respective layer of the conductor assembly 102 by forming a longitudinal tube around the conductor core 114 and/or the insulation 118, where the longitudinal tube of the sheet may form an overlapping seam. The overlapping seam of the longitudinal tube may be sealed (e.g., hermetically sealed) by any suitable method to form at least a portion of the conductor shield 116 and/or the insulation shield 120. In another example, the tape may be prepared as a strip capable of or configured to be helically wrapped around the conductor core 114 and/or the insulation 118 to form at least a portion of the conductor shield 116 and/or the insulation shield 120, respectively. The tape in the form of the strip may be disposed about the conductor core 114 and/or the insulation 118 with an overlap, thereby providing or forming an overlapping seam and/or providing a plurality of layers of the wrap over the conductor core 114 and/or the insulation 118.

The semiconducting cable tape may have an electrical resistivity of from about 0.01 ohm-meter to about 1 ohm-meter, about 50 ohm-cm to about 10,000 ohm-cm, or about 1 ohm-cm to about 100 ohm-cm.

The semiconducting cable tape may have a volume resistivity of from about 0.01 ohm-meter to about 1 ohm-meter or about 1 ohm-cm to about 100 ohm-cm.

The semiconducting cable tape including the nonwoven sheet may have a penetration resistance relatively greater than conventional semiconducting cable tapes including woven sheets. For example, the semiconducting cable tape may have a penetration resistance significantly, surprisingly, and unexpectedly greater than conventional semiconducting cable tapes prepared from woven sheets.

As used herein, the “penetration resistance” of a respective sheet (e.g., nonwoven or woven sheet) may be measured by determining an amount (e.g., percentage [%]) of a material that passes through the sheet when force and/or heat is applied to the material disposed adjacent the sheet. For example, the penetration resistance of a nonwoven sheet may be measured by disposing a polymer sheet (i.e., the penetrating material), such as a polyethylene polymer sheet, on a first side or face of the nonwoven sheet, applying heat and/or pressure on the polymer sheet towards the nonwoven sheet, and determining an amount (e.g., percentage [%]) of the polymer sheet that passes through the nonwoven sheet. The heat and/or pressure applied to the polymer sheet may each be consistent or varied. The time for applying the heat and/or pressure may be the same between samples and/or predetermined. In at least one implementation, the penetration resistance of the nonwoven sheet or the amount of material that passes through the nonwoven sheet may be less than 10%, less than 5%, less than 4%, less than 3%, less than 2%, or less than 1%. For example, the penetration resistance of the nonwoven sheet or the amount of a polyethylene polymer sheet that passes through the nonwoven sheet may be less than 10%, less than 5%, less than 4%, less than 3%, less than 2%, or less than 1%, when heated at about 130° C. to about 190° C., about 150° C. to about 170° C., or about 160° C.

The “penetration resistance” of a respective sheet may also be measured by determining the amount of force sufficient to push the material through the sheet. For example, the penetration resistance of a nonwoven sheet may be measured by disposing a polymer sheet (i.e., the penetrating material), such as a polyethylene polymer sheet, on the first side of the nonwoven sheet, applying a pressure (e.g., increasing pressure) on the polymer sheet towards the nonwoven sheet, and determining the pressure (i.e., newtons [N]) sufficient to press at least a portion of the polymer sheet through the nonwoven sheet. In at least one implementation, the penetration resistance of the nonwoven sheet or the pressure sufficient to push the material through the nonwoven sheet, at a predetermined temperature (e.g., about 130° C. to about 190° C., about 150° C. to about 170° C., or about 160° C.), may be from about 200 Newtons (N) or greater to about 1200 N or greater. For example, the penetration resistance of the nonwoven sheet may be about 200 N or greater, about 300 N or greater, about 400 N or greater, about 500 N or greater, about 600 N or greater, about 700 N or greater, about 800 N or greater, or about 900 N or greater. In another example, the penetration resistance may be from about 200 N to about 1200 N, about 500 N to about 900 N, or about 600 N to about 800 N.

The semiconducting cable wrap or tape may be capable of or configured to provide one or more of the following functions and/or properties as compared to conventional semiconducting cable wraps/tapes: relatively higher abrasion resistance, improved fire performance and/or resistance, faster application, relatively greater electrical resistance, relatively reduced slippage, improved temperature stability, increased penetration resistance, improved breaking strength, relatively increased elongation, or the like.

As discussed above, the nonwoven sheet may be prepared from a plurality of fibers. The plurality of fibers may be prepared from one or more polymers, one or more resins (e.g., synthetic resins), one or more copolymers thereof, or any combination thereof. For example, the nonwoven sheet and/or the plurality of fibers thereof may be prepared from a single polymer, a single copolymer, or a single synthetic resin. In another example, the nonwoven sheet and/or the plurality of fibers thereof may be prepared from a plurality of polymers, resins, copolymers, or any combination thereof. In at least one example, the nonwoven sheet may be prepared from a first plurality of fibers and a second plurality of fibers, wherein the second plurality of fibers is different than the first plurality of fibers. It should be appreciated that the nonwoven sheet may be prepared from any number of fibers. For example, the nonwoven sheet may include a first plurality of fibers, a second plurality of fibers, a third plurality of fibers, a fourth plurality of fibers, or more, where each of the respective pluralities of fibers are different from the remaining plurality of fibers. As used herein, the differences between any of the plurality of fibers may be or include, but is not limited to, a molecular weight, a melting point, a glass transition temperature, an average fiber length, an average fiber diameter, a composition, one or more physical properties (e.g., mechanical strength, tensile strength, tenacity, etc.), or the like, or any combination thereof.

In an exemplary implementation, the nonwoven sheet includes a first plurality of fibers prepared from a synthetic resin. The synthetic resin may be or include a polycondensation product of dicarboxylic acids with dihydroxy alcohols. In an exemplary implementation, the first plurality of fibers may be prepared from one or more polyester resins. Accordingly, the first plurality of fibers may be or include polyester fibers or filaments. The first plurality of fibers may be or include drawn fibers. In an exemplary implementation, the first plurality of fibers may be or include polyethylene terephthalate (PET) fibers.

In at least one implementation, the nonwoven sheet includes the first plurality of fibers and a second plurality of fibers. The second plurality of fibers may be capable of or configured to increase a strength of the nonwoven sheet by fusing, welding, or otherwise coupling fibers (e.g., first and/or second plurality of fibers) of the nonwoven sheets with one another. For example, the second plurality of fibers may be capable of or configured to couple fibers (e.g., the first and/or second plurality of fibers) of the nonwoven sheet with one another at intersecting or intersection points formed with respective fibers of the second plurality of fibers. The second plurality of fibers may be or include, but are not limited to, one or more thermoplastic compositions or fibers. Illustrative thermoplastic compositions may be or include, but are not limited to, polyester, polyolefin, nylon, alamide, polyphenylene sulfide, or the like, or any combination thereof. In an exemplary implementation the second plurality of fibers includes polyester fibers or filaments prepared from polyester resins. The polyester fibers or filaments of the second plurality of fibers may be undrawn polyester fibers. In an exemplary implementation, the second plurality of fibers may be or include polyethylene terephthalate (PET) fibers. The polyester fibers or filaments of the second plurality of fibers may have a melting point and/or glass transition temperature relatively lower than the melting point and/or glass transition temperature of the first plurality of fibers. For example, the polyester fibers of the second plurality of fibers may have a melting point and a glass transition temperature relatively lower than the melting point and glass transition temperature of the polyester fibers of the first plurality of fibers. The relatively lower melting point and/or glass transition temperature of the second plurality of fibers may facilitate the fusing, welding, binding, or otherwise coupling of the fibers of the nonwoven sheet via thermal heating (e.g., thermal pressing, calendaring, etc.). The melting point of the second plurality of fibers or the polyester fibers thereof may be from about 120° C. to about 260° C.

The nonwoven sheet may include the first plurality of fibers and the second plurality of fibers in varying weight ratios. For example, the weight ratio of the first plurality of fibers to the second plurality of fibers may be from about 1:5 (about 1 to about 5) to about 5:1. In one example, the weight ratio of the first plurality of fibers to the second plurality of fibers may be from about 1:5, about 2:5, about 3:5, about 4:5, or about 5:5 to about 5:4, about 5:3, about 5:2, or about 5:1. In yet another example, the weight ratio of the first plurality of fibers to the second plurality of fibers may be from about 1:10 to about 10:1.

The nonwoven sheet including the first plurality of fibers and the second plurality of fibers may include the first plurality of fibers in an amount of from about 10 wt % to about 90 wt %, based on the total weight of the first plurality of fibers and the second plurality of fibers. For example, the first plurality of fibers may be present in the nonwoven sheet in an amount of from about 10 wt %, about 20 wt %, about 30 wt %, or about 40 wt % to about 50 wt %, about 60 wt %, about 70 wt %, about 80 wt %, or about 90 wt %, based on the total weight of the first plurality of fibers and the second plurality of fibers. In another example, the first plurality of fibers may be present in the nonwoven sheet in an amount of from about 10 wt % to about 90 wt %, about 20 wt % to about 80 wt %, about 30 wt % to about 70 wt %, or about 40 wt % to about 60 wt %, based on the total weight of the first plurality of fibers and the second plurality of fibers.

The nonwoven sheet including the first plurality of fibers and the second plurality of fibers may include the second plurality of fibers in an amount of from about 10 wt % to about 90 wt %, based on the total weight of the first plurality of fibers and the second plurality of fibers. For example, the second plurality of fibers may be present in the nonwoven sheet in an amount of from about 10 wt %, about 20 wt %, about 30 wt %, or about 40 wt % to about 50 wt %, about 60 wt %, about 70 wt %, about 80 wt %, or about 90 wt %, based on the total weight of the first plurality of fibers and the second plurality of fibers. In another example, the second plurality of fibers may be present in the nonwoven sheet in an amount of from about 10 wt % to about 90 wt %, about 20 wt % to about 80 wt %, about 30 wt % to about 70 wt %, or about 40 wt % to about 60 wt %, based on the total weight of the first plurality of fibers and the second plurality of fibers. The second plurality of fibers may be present in an amount sufficient to provide the nonwoven sheet of the semiconducting cable tape with a sufficient strength and/or a sufficiently uniform surface. In an exemplary implementation, the second plurality of fibers may be present in an amount of from about 20 wt % to about 80 wt % or about 30 wt % to about 70 wt %, based on the total weight of the first and second plurality of fibers, to thereby provide the nonwoven sheet with a sufficient strength and/or a sufficiently uniform (e.g., even) surface.

The nonwoven sheet may be prepared by mixing, dispersing, or otherwise contacting the first plurality of fibers and the second plurality of fibers with one another according to any conventional manufacturing process. For example, the first plurality of fibers and the second plurality of fibers may be combined with one another via a dry manufacturing process or a wet manufacturing process. The nonwoven sheet may include a combination or mixture of each of the first and second plurality of fibers. The nonwoven sheet may also include one or more layers of the first plurality of fibers and one or more layers of the second plurality of fibers. In another example, the nonwoven sheet may include one or more layers of the first plurality of fibers, one or more layers of the second plurality of fibers, one or more layers of a mixture of the first and second plurality of fibers, or any combination thereof. One or more reagents or agents may be added during the manufacturing process to facilitate the fabrication or preparation of the nonwoven sheet. The one or more reagents and/or agents may be or include, but are not limited to, one or more dispersants, co-dispersants, defoaming agents, hydrophilic agents, antistatic agents, or the like, or any combination thereof. The nonwoven sheet may be prepared by disposing respective layers of the first plurality of fibers adjacent to respective layers of the second plurality of fibers. The respective layers of the first and second plurality of fibers may be disposed adjacent to one another in a pattern, such as an alternating and/or repeating pattern. The respective layers of the first and second plurality of fibers may also be disposed adjacent to one another in a random order.

The nonwoven sheet may be subjected to one or more heating and/or pressing processes. For example, the nonwoven sheet prepared from the first plurality of fiber and the second plurality of fibers may be pressed with one or more rollers. In another example, the nonwoven sheet prepared from the first plurality of fiber and the second plurality of fibers may be pressed and heated with one or more rollers. The nonwoven sheet may be heated and/or pressed as a single layer or as a plurality of layers. For example, the nonwoven sheet may include, at least, a first layer of the first plurality of fibers and a second layer of the second plurality of fibers. In another example, the nonwoven sheet may include, at least, a first layer including the first and second plurality of fibers, and a second layer including either the first plurality of fibers or the second plurality of fibers. In yet another example, the nonwoven sheet may include a plurality of layers including the first plurality of fibers and a plurality of layers including the second plurality of fibers. The layers of the nonwoven sheet may be repeating layers, alternating layers, random layers, or a combination thereof.

It should be appreciated that one or more variables of the heating and/or pressing processes may be modified to at least partially adjust one or more characteristics or properties of the nonwoven sheet. For example, the temperature of the respective surface of each of the rollers, the pinching force of the rollers, the transporting velocity of the nonwoven sheet, time of pressing, or the like, may be modified to at least partially adjust one or more characteristics or properties of the nonwoven sheet. The one or more characteristics or properties of the nonwoven sheet that may be modified via the variables of the heating and/or pressing processes may be or include, but are not limited to, the permeability of the nonwoven sheet, the average roughness of the nonwoven sheet (e.g., centerline average roughness) at the first and/or second sides or faces. The temperature of the roller, if utilized, may be from about 100° C. to about 300° C., about 130° C. to about 280° C., about 150° C. to about 270° C., about 200° C. to about 260° C., or about 200° C. to about 230° C. The pinching force of the rollers may be from about 10 kg/cm to about 200 kg/cm, about 50 kg/cm to about 150 kg/cm, or about 75 kg/cm to about 100 kg/cm. The transporting velocity may be from about 10 m/min to about 150 m/min, about 25 m/min to about 100 m/min, or about 60 m/min to about 75 m/min.

In at least one implementation, the difference between a respective average roughness or centerline average roughness of the first face and the second face of the nonwoven sheet may be greater than or equal to about 10%, greater than or equal to about 15%, greater than or equal to about 20%, greater than or equal to about 25%. In another implementation, the difference between a respective average roughness or centerline average roughness of the first face and the second face of the nonwoven sheet may be less than or equal to about 10%, less than or equal to about 15%, less than or equal to about 20%, less than or equal to about 25%.

The nonwoven sheet prepared from the first plurality of fibers including polyester fibers or filaments may have a single fiber fineness of from about 0.5 decitex (dtex) to about 9.0 dtex. For example, the nonwoven sheet prepared from the first plurality of fibers including polyester fibers or filaments may have a single fiber fineness of from about 0.5 dtex, about 0.6 dtex, about 1 dtex, about 2 dtex, about 3 dtex, or about 4 dtex to about 5 dtex, about 6 dtex, about 6.5 dtex, about 6.7 dtex, about 7 dtex, about 8 dtex, or about 9 dtex. In another example, the nonwoven sheet prepared from the first plurality of fibers including polyester fibers or filaments may have a single fiber fineness of from about 0.5 dtex to about 9 dtex, about 0.6 dtex to about 6.7 dtex, or about 1 dtex to about 6 dtex. It should be appreciated that the single fiber fineness may be adjusted to at least partially modify or adjust one or more properties of the nonwoven sheet including, but not limited to, air permeability, average pore size, or any combination thereof.

The nonwoven sheet prepared from the first plurality of fibers including the polyester fibers or filaments may have an air permeability of from about 0.5 cc/cm²/sec to about 7 cc/cm²/sec. For example, the nonwoven sheet prepared from the first plurality of fibers including the polyester fibers or filaments may have an air permeability of from about 0.5 cc/cm²/see, about 1 cc/cm²/see, about 2 cc/cm²/see, or about 3 cc/cm²/sec to about 5 cc/cm²/see, about 6 cc/cm²/see, or about 7 cc/cm²/sec. In another example, the nonwoven sheet prepared from the first plurality of fibers including the polyester fibers or filaments may have an air permeability of from about 0.5 cc/cm²/sec to about 7 cc/cm²/see, about 1 cc/cm²/sec to about 6 cc/cm²/see, about 3 cc/cm²/sec to about 5 cc/cm²/sec. In yet another example, the nonwoven sheet prepared from the first plurality of fibers may have an air permeability of from about 0.5 cc/cm²/sec to about 1.0 cc/cm²/see, about 0.6 cc/cm²/sec to about 0.9 cc/cm²/see, or about 0.7 cc/cm²/sec.

The nonwoven sheet prepared from the first plurality of fibers including the polyester fibers or filaments may have an average pore size of from about 5 μm to about 15 μm. For example, the nonwoven sheet prepared from the first plurality of fibers including the polyester fibers or filaments may have an average pore size of from about 5 μm, about 7 μm, or about 9 μm to about 11 μm, about 13 μm, or about 15 μm. In another example, the nonwoven sheet prepared from the first plurality of fibers including the polyester fibers or filaments may have an average pore size of from about 5 μm to about 15 μm, about 7 μm to about 13 μm, or about 9 μm to about 11 μm.

The nonwoven sheet prepared from the first plurality of fibers and/or the second plurality of fibers may have a single fiber fineness of from about 0.5 dtex to about 9.0 dtex. For example, the nonwoven sheet prepared from the first plurality of fibers and/or the second plurality of fibers may have a single fiber fineness of from about 0.5 dtex, about 0.6 dtex, about 1 dtex, about 2 dtex, about 3 dtex, or about 4 dtex to about 5 dtex, about 6 dtex, about 6.5 dtex, about 6.7 dtex, about 7 dtex, about 8 dtex, or about 9 dtex. In another example, the nonwoven sheet prepared from the first plurality of fibers and/or the second plurality of fibers may have a single fiber fineness of from about 0.5 dtex to about 9 dtex, about 0.6 dtex to about 6.7 dtex, or about 1 dtex to about 6 dtex. It should be appreciated that the single fiber fineness may be adjusted to at least partially modify or adjust one or more properties of the nonwoven sheet including, but not limited to, air permeability, average pore size, or any combination thereof.

The nonwoven sheet prepared from the first plurality of fibers and/or the second plurality of fibers may have an air permeability of from about 0.5 cc/cm²/sec to about 7 cc/cm²/sec. For example, the nonwoven sheet prepared from the first plurality of fibers and/or the second plurality of fibers may have an air permeability of from about 0.5 cc/cm²/see, about 1 cc/cm²/see, about 2 cc/cm²/see, or about 3 cc/cm²/sec to about 5 cc/cm²/see, about 6 cc/cm²/see, or about 7 cc/cm²/sec. In another example, the nonwoven sheet prepared from the first plurality of fibers and/or the second plurality of fibers may have an air permeability of from about 0.5 cc/cm²/sec to about 7 cc/cm²/see, about 1 cc/cm²/sec to about 6 cc/cm²/see, about 3 cc/cm²/sec to about 5 cc/cm²/sec. In yet another example, the nonwoven sheet prepared from the first plurality of fibers and/or the second plurality of fibers may have an air permeability of from about 0.5 cc/cm²/sec to about 1.0 cc/cm²/see, about 0.6 cc/cm²/sec to about 0.9 cc/cm²/see, or about 0.7 cc/cm²/sec.

The nonwoven sheet prepared from the first plurality of fibers and/or the second plurality of fibers may have an average pore size of from about 5 μm to about 15 μm. For example, the nonwoven sheet prepared from the first plurality of fibers and/or the second plurality of fibers may have an average pore size of from about 5 μm, about 7 μm, or about 9 μm to about 11 μm, about 13 μm, or about 15 μm. In another example, the nonwoven sheet prepared from the first plurality of fibers and/or the second plurality of fibers may have an average pore size of from about 5 μm to about 15 μm, about 7 μm to about 13 μm, or about 9 μm to about 11 μm.

In at least one implementation, a casting solution, such as a polymer casting solution, may be applied to the nonwoven sheet. The casting solution may be applied to the first face or surface, the second face or surface, or a combination thereof. The casting solution may be applied to the nonwoven sheet before or after the heating and/or pressing processes. The casting solution may be applied via any suitable or conventional process including, but not limited to, dip coating, spraying, or the like, or any combination thereof.

The casting solution may include a polysulfone dispersed, mixed, or otherwise combined with a suitable solvent. The solvent may be any solvent capable of or configured to disperse the polysulfone, such as, but not limited to, N,N-dimethylformamide (DMF). The polysulfone may be present in the casting solution in an amount of from about 5 wt % to about 25 wt %, about 10 wt % to about 20 wt %, or about 15 wt %, based on the total weight of the casting solution. The polysulfone may be present in an amount sufficient to provide a barrier to one or more gases.

The nonwoven sheet may be treated with the casting solution such that a polysulfone layer of from about 20 μm to about 100 μm may be disposed on the nonwoven sheet and/or the fibers thereof. For example, the polysulfone layer may be disposed on the fibers of the nonwoven sheet. In another example, the polysulfone layer may be disposed on the first face and/or the second face of the nonwoven sheet.

In at least one implementation, an active layer or skin layer may be coated on the first face and/or the second face of the nonwoven sheet. The active layer may be or include, but is not limited to, cellulose, cellulose acetate, polyamides, polyimides, or the like, or any combination thereof. The active layer may have a thickness relatively less than the thickness of the nonwoven sheet.

In at least one implementation, the nonwoven sheet may be treated with a semiconductive composition. The semiconductive composition may be capable of or configured to provide semiconductive properties to the nonwoven sheet of the semiconducting cable tape. For example, the semiconductive composition may allow the semiconducting cable tape to prevent a space charge between insulating and conductive layers or components of the conductor assembly 102. The semiconductive composition may be contacted with the nonwoven sheet such that the semiconductive composition impregnates or penetrates through a thickness or depth of the nonwoven sheet. The semiconductive composition may be contacted with the nonwoven sheet such that the semiconductive composition at least partially coats the fibers of the nonwoven sheet. The semiconductive composition may also be capable of or configured to facilitate the binding or coupling of the fibers of the nonwoven sheet with one another to thereby reduce penetration therethrough and/or increase penetration resistance thereof. The semiconductive composition may be contacted with the nonwoven sheet to fill voids or a volume defined between respective fibers of the nonwoven sheets. For example, the fibers of the nonwoven sheet may define voids or a volume therebetween, and the semiconductive composition may at least partially fill or otherwise be dispose in the voids and volume to thereby reduce the respective size of the voids and volume. The semiconductive composition may be applied to the first face or surface, the second face or surface, or a combination thereof. The semiconductive composition may be applied to the nonwoven sheet before or after the heating and/or pressing processes. The semiconductive composition may be applied via any suitable process including, but not limited to, dip coating, spraying, or the like, or any combination thereof.

The semiconductive composition may include one or more conductive materials, one or more resins or polymers, a crosslinking agent, or any combination thereof. In an exemplary implementation, the semiconductive composition includes at least a base resin and one or more conductive materials disposed in, dispersed in, mixed with, or otherwise contacted with the base resin.

The base resin or polymer may at least partially protect the one or more conductive materials and/or the fibers of the nonwoven sheet. The base resin or polymer may be or include, but is not limited to, one or more polyolefin-based resins, such as polypropylene-based and/or polyethylene-based resins, copolymers of an olefin, such as a copolymer of an olefin with an ethylenically unsaturated ester, polyesters, polycarbonates, polysulphones, phenol resins, urea resins, acrylic or acrylate polymers or polyacrylates, copolymers thereof, or the like, or any combination thereof. Illustrative resins or polymers may be or include, but are not limited to, one or more of polyethylene (PE), low density PE (LDPE), medium density PE (MDPE), high density PE (HDPE), linear low density PE (LLDPE), ultra-low density polyethylene (ULDPE), polypropylene (PP), elastomeric ethylene/propylene copolymers (EPR) or ethylene/propylene/diene terpolymers (EPDM), natural rubber, butyl rubber, ethylene/vinyl ester copolymers, for example ethylene/vinyl acetate (EVA), ethylene/acrylate copolymers, in particular ethylene/methyl acrylate (EMA), ethylene/ethyl acrylate (EEA) and ethylene/butyl acrylate (EBA), ethylene/alpha-olefin thermoplastic copolymers, polystyrene, acrylonitrile/butadiene/styrene (ABS) resins, halogenated polymers, in particular polyvinyl chloride (PVC), polyurethane (PUR), polyamides, aromatic polyesters such as polyethylene terephthalate (PET) or polybutylene terephthalate (PBT), copolymers thereof, or the like, or any combination thereof. The base resin or polymer may be in the form of an aqueous dispersion. In an exemplary implementation, the base resin or polymer may be or include an aqueous dispersion of an acrylic polymer and/or an acrylic copolymer having a solid content of about 45%, a pH of about 4.0, a viscosity at 25° C. of less than 100 mPas, and/or a glass transition temperature (DSC) (Tg) of about −30° C. The aqueous dispersion of the acrylic polymer and/or the acrylic copolymer may include a self-crosslinking acrylic copolymer dispersion, which may be surfactant stabilize, and may have fine particle sizes.

The base resin or polymer may be present in an amount of from about 5 wt % to about 90 wt % or more, based on the total weight of the semiconductive composition. For example, the base resin or polymer may be present in an amount of from about 5 wt %, about 10 wt %, about 20 wt %, about 30 wt %, about 40 wt %, or about 50 wt % to about 60 wt %, about 70 wt %, about 80 wt %, about 90 wt %, or more, based on the total weight of the semiconductive composition.

The one or more conductive materials may be uniformly and homogenously dispersed in the based resin or polymer. The one or more conductive materials may be or include, but are not limited to, one or more metallic conductive particles (e.g., aluminum particles, silver particles, etc.), carbon black (e.g., furnace black, channel black, acetylene black, etc.), graphite, graphene, carbon nanotubes, or the like, or any combination thereof. In an exemplary implementation, the conductive material includes carbon black. The carbon black may have a surface area of from about 10 m²/g to about 1000 m²/g.

The one or more conductive materials may be present in an amount sufficient to obtain the resistivity or volumetric resistivity described herein. The one or more conductive materials may also be present in an amount sufficient to provide a suitable viscosity for the semiconducting composition. For example, increasing the amount of the conductive materials may correspondingly increase a viscosity of the semiconducting composition, thereby reducing the ease or ability to coat or dispose the semiconducting composition throughout the nonwoven sheet or the fibers thereof. In one example, the one or more conductive materials may be present in an amount of from about 1 wt % to about 50 wt %, based on the total weight of the semiconductive composition.

The crosslinking agent may be or include any crosslinking agent suitable for use with the base resin or polymer. Illustrative crosslinking agents may be or include, but are not limited to, peroxide-based, silane-based cross-linking agents, azo-compounds, or the like, or any combination thereof. The crosslinking agent may be present in an amount of from about 0.1 wt % to about 3 wt %, based on the total weight of the semiconductive composition. In at least one implementation, crosslinking of the base resin or polymer may be performed via radiation or other conventional process known in the art.

In at least one implementation, the semiconductive composition may include one or more additives or fillers to provide or modify one or more properties thereof. Illustrative additives may be or include, but are not limited to, stabilizers such as antioxidants, nucleating agents, inorganic fillers, cross-linkers, cross-linking boosters, scorch retard agents, flame retardants, thickeners, viscosity modifying agents, or the like, or any combination thereof. The one or more additives or fillers may be present in an amount of from about 0.01 wt % to about 30 wt %, based on the total weight of the semiconductive composition.

In an exemplary implementation, the semiconductive composition includes a flame retardant material. Illustrative flame retardant materials may be or include, but are not limited to, aluminum trihydroxide, vermiculite, clay, or the like, or any combination thereof.

In at least one implementation, the semiconducting cable tape may include a flame retardant layer or sheet disposed proximal or adjacent to the nonwoven sheet of the semiconducting cable tape. The flame retardant layer may include any one or more of aluminum trihydroxide, vermiculite, clay, or any combination thereof.

In at least one implementation, the semiconducting cable tape may include an adhesive coupled with the nonwoven sheet to facilitate the adhesion thereof. Any suitable adhesive may be utilized. In an exemplary implementation, no adhesives is utilized. For example, the semiconducting cable tape may be a “technical” cloth or textile capable of or configured to be helically wrapped about one or more components of the conductor assembly 102 and held in place via tension and/or friction. For example, the semiconducting cable tape may not be tacky or self-adhering.

In an exemplary implementation, the semiconductive composition includes one or more thickeners and/or viscosity modifying agents. The thickeners and/or viscosity modifying agents may be present in an amount of from about 0.01 wt % to about 30 wt %, based on the total weight of the semiconductive composition. Illustrative thickeners and/or viscosity modifying agents may be or include, but are not limited to, one or more of the following: alkali swellable emulsions (ASE); hydrophobically modified alkali swellable emulsions (HASE); hydrophobically modified polyurethanes (HEUR); hydrophobically modified polyethers (HMPE); attapulgites (inorganic rheology modifiers); castor oil, wax, and/or urea based thixotropes; alkali-soluble (associatives); carboxylic and polycarboxylic acids; cellulosics; aqueous solutions of a synthetic polyacrylate, or the like, or any combination thereof. The thickeners and/or viscosity modifying agents may also be or include, but are not limited to, one or more of the following: RHEOVIS®, ATTAGEL®, ATTAFLOW®, and/or EFKA® rheology modifiers for water-based, solvent-based, and solvent-free formulations, each of which are commercially available from BASF of Ludwigshafen, Germany. In an exemplary implementation, the thickener may be or include a high viscosity, anionic, aqueous solution of a synthetic polyacrylate that is ammonia free. The thickener may have a viscosity of from about 13,000 centipoise (cP) to about 14,000 cP, a total solids content of from about 9% to about 13% or about 10% to about 12%, and/or a pH of from about 10 to about 12 or about 10 to about 10.5.

The nonwoven sheet, prior to treatment with the semiconductive composition, may have a weight, according to ISO 536 standards, of from about 50 g/m² to about 100 g/m², or about 75 g/m².

The nonwoven sheet, prior to treatment with the semiconductive composition, may have a thickness, according to ISO 534 standards, of from about 50 μm to about 150 μm, about 80 μm to about 120 μm, about 60 μm to about 80 μm, or about 70 μm.

The nonwoven sheet, prior to treatment with the semiconductive composition, may have an air permeability, as measured according to ASTM testing methods such as ASTM D737, of from about 0.5 cc/cm²/sec to about 1 cc/cm²/see, about 0.6 cc/cm²/sec to about 0.9 cc/cm²/see, or about 0.7 cc/cm²/sec.

The nonwoven sheet, prior to treatment with the semiconductive composition, may have a tensile strength, according to WSP 110.4, of mini 8 200 cN/15 mm or mini 3 600 cN/15 mm.

The nonwoven sheet, prior to treatment with the semiconductive composition, may have a breaking strength true warp, as measured according to ASTM testing methods such as ASTM D5034 or ASTM D1000, of from about 30 N/cm to about 90 N/cm, about 40 N/cm to about 80 N/cm, about 40 N/cm to about 60 N/cm, about 45 N/cm to about 55 N/cm, or about 50 N/cm.

The nonwoven sheet, prior to treatment with the semiconductive composition, may have an elongation true warp, as measured according to ASTM testing methods such as ASTM 4632 or ASTM D1000, of from about 5% to about 40%, about 5% to about 30%, about 10% to about 26%, about 6% to about 9%, about 10%, or about 8%.

The nonwoven sheet, prior to treatment with the semiconductive composition, may have a breaking strength weft, as measured according to ASTM testing methods such as ASTM D5034 or ASTM D1000, of from about 15 N/cm to about 50 N/cm, about 20 N/cm to about 25 N/cm, or about 23 N/cm.

The nonwoven sheet, prior to treatment with the semiconductive composition, may have an elongation weft, as measured according to ASTM testing methods such as ASTM D5034 or ASTM D1000, of from about 5% to about 40%, about 5% to about 35%, about 10% to about 30%, about 6% to about 9%, or about 8%.

The nonwoven sheet, after treatment with the semiconductive composition on the first or second side thereof, may have a weight, according to ISO 536 standards, of from about 50 g/m² to about 100 g/m², about 65 g/m² to about 90 g/m², about 80 to about 90 g/m², or about 85 g/m².

The nonwoven sheet, after treatment with the semiconductive composition on the first or second side thereof, may have a thickness, according to ISO 534 standards, of from about 50 μm to about 150 μm, about 70 μm to about 130 μm, about 80 μm to about 120 μm, about 65 μm to about 85 μm, about 70 μm to about 80 μm, about 100 μm, or about 75 μm.

The nonwoven sheet, after treatment with the semiconductive composition on the first or second side thereof, may have an air permeability, as measured according to ASTM testing methods such as ASTM D737, of from about 0.5 cc/cm²/sec to about 1 cc/cm²/see, about 0.6 cc/cm²/sec to about 0.9 cc/cm²/see, or about 0.7 cc/cm²/sec.

The nonwoven sheet, after treatment with the semiconductive composition, may have a tensile strength, according to WSP 110.4, of mini 8 200 cN/15 mm or mini 3 600 cN/15 mm.

The nonwoven sheet, after treatment with the semiconductive composition on the first or second side thereof, may have a breaking strength true warp, as measured according to ASTM testing methods such as ASTM D5034, relatively greater than prior to treatment with the semiconductive composition. For example, the nonwoven sheet treated with the semiconductive composition may have a breaking strength true warp of from about 30 N/cm to about 90 N/cm or greater, about 45 N/cm to about 65 N/cm, about 50 N/cm to about 60 N/cm, or about 55 N/cm.

The nonwoven sheet, after treatment with the semiconductive composition on the first or second side thereof, may have an elongation true warp, as measured according to ASTM testing methods such as ASTM 4632, relatively greater than prior to treatment with the semiconductive composition. For example, the nonwoven sheet treated with the semiconductive composition may have an elongation true warp of from about 6% to about 40%, about 10% to about 30%, about 10%, about 20%, or about 8.5%.

The nonwoven sheet, after treatment with the semiconductive composition on the first or second side thereof, may have a breaking strength weft, as measured according to ASTM testing methods such as ASTM D5034, relatively greater than prior to treatment with the semiconductive composition. For example, the nonwoven sheet treated with the semiconductive composition may have a breaking strength weft of from about 20 N/cm to about 60 N/cm, about 25 N/cm to about 30 N/cm, or about 28 N/cm.

The nonwoven sheet, after treatment with the semiconductive composition on the first or second side thereof, may have an elongation weft, as measured according to ASTM testing methods such as ASTM D5034, relatively greater than prior to treatment with the semiconductive composition. For example, the nonwoven sheet treated with the semiconductive composition may have an elongation weft of from about 6% to about 45%, about 7% to about 10%, or about 9%.

The nonwoven sheet treated with the semiconductive composition on the first or second side thereof may have a volume resistivity of from about 0.01 ohm-meter (Ω-m) to about 1 Ω-m or about 1 ohm-cm to about 100 ohm-cm. For example, the nonwoven sheet may have a volume resistivity of from about 0.01 Ω-m to about 0.5 Ω-m, about 0.02 Ω-m to about 0.4 Ω-m, about 0.04 Ω-m to about 0.35 Ω-m, or about 0.05 Ω-m to about 0.26 Ω-m. In another example, the nonwoven sheet may have a volume resistivity of from about 1 Ω-cm to about 100 Ω-cm, about 5 Ω-cm to about 95 Ω-cm, about 25 Ω-cm to about 75 Ω-cm, about 40 Ω-cm to about 60 Ω-cm. In at least one implementation, the volume resistivity may be from about 5 Ω-cm to about 10 Ω-cm, or about 6 Ω-cm to about 8 Ω-cm.

The nonwoven sheet treated with the semiconductive composition on the first or second side thereof may have a current, as measured at about 100° C., of from about 0.1 Ω/m to about 0.3 Ω/m, about 0.15 Ω/m to about 0.25 Ω/m, about 0.15 to about 0.2 Ω/m, or about 0.18 Ω/m.

The nonwoven sheet treated with the semiconductive composition on the first or second side thereof may have a current of from about 100 Ω/cm to about 200 Ω/cm, about 125 Ω/cm to about 175 Ω/cm, or about 150 Ω/cm.

The nonwoven sheet treated with the semiconductive composition on the first or second side thereof may have a through resistivity of from about 75Ω to about 175Ω, about 100Ω to about 150Ω, or about 125Ω. In another example, the nonwoven sheet treated with the semiconductive composition on the first or second side thereof may have a through resistivity of from about 1Ω to about 15Ω, about 3Ω to about 10Ω, about 4Ω to about 9Ω, or about 6Ω to about 8Ω.

The nonwoven sheet treated with the semiconductive composition on the first or second side thereof may have a resistivity of from about 800 Ω/sq to about 3500 Ω/sq, about 1500 Ω/sq to about 3000 Ω/sq, about 2500 Ω/sq to about 2800 Ω/sq, or about 2700 Ω/sq.

The nonwoven sheet, after treatment with the semiconductive composition on the first and second sides thereof, may have a weight, according to ISO 536 standards, of from about 50 g/m² to about 100 g/m², about 65 g/m² to about 95 g/m², about 80 to about 90 g/m², or about 95 g/m².

The nonwoven sheet, after treatment with the semiconductive composition on the first and second sides thereof, may have a thickness, according to ISO 534 standards, of from about 50 μm to about 150 μm, about 80 μm to about 120 μm, about 70 μm to about 90 μm, about 75 μm to about 85 μm, or about 80 μm.

The nonwoven sheet, after treatment with the semiconductive composition on the first and second sides thereof, may have an air permeability, according to ASTM D737, of from about 0.1 cc/cm²/sec to about 1 cc/cm²/see, about 0.2 cc/cm²/sec to about 0.8 cc/cm²/see, or about 0.5 cc/cm²/sec.

The nonwoven sheet, after treatment with the semiconductive composition on the first and second sides thereof, may have a breaking strength true warp, as measured according to ASTM testing methods such as ASTM D5034, of from about 40 N/cm to about 80 N/cm, about 50 N/cm to about 70 N/cm, about 55 N/cm to about 65 N/cm, or about 57 N/cm.

The nonwoven sheet, after treatment with the semiconductive composition on the first and second sides thereof, may have an elongation true warp, as measured according to ASTM testing methods such as ASTM 4632, of from about 10% to about 40%, about 5% to about 15%, about 8% to about 13%, or about 10%.

The nonwoven sheet, after treatment with the semiconductive composition on the first and second sides thereof, may have a breaking strength weft, as measured according to ASTM testing methods such as ASTM D5034, of from about 25 N/cm to about 60 N/cm, about 30 N/cm to about 35 N/cm, or about 32 N/cm.

The nonwoven sheet, after treatment with the semiconductive composition on the first and second sides thereof, may have an elongation weft, as measured according to ASTM testing methods such as ASTM D5034, of from about 5% to about 45%, about 8% to about 13%, about 9% to about 12%, or about 11%.

The nonwoven sheet treated with the semiconductive composition on the first and second sides thereof may have a volume resistivity of from about 0.01 ohm-meter (Ω-m) to about 0.5 Ω-m or about 1 Ω-cm to about 100 Ω-cm. For example, the nonwoven sheet may have a volume resistivity of from about 0.01 Ω-m to about 0.5 Ω-m, about 0.02 Ω-m to about 0.4 Ω-m, about 0.04 Ω-m to about 0.35 Ω-m, or about 0.05 Ω-m to about 0.26 Ω-m. In another example, the nonwoven sheet may have a volume resistivity of from about 1 Ω-cm to about 100 Ω-cm, about 5 Ω-cm to about 95 Ω-cm, about 25 Ω-cm to about 75 Ω-cm, about 40 Ω-cm to about 60 Ω-cm. In at least one implementation, the volume resistivity may be from about 5 Ω-cm to about 10 Ω-cm, or about 6 Ω-cm to about 8 Ω-cm.

The nonwoven sheet treated with the semiconductive composition on the first and second side thereof may have a current, as measured at about 100° C., of from about 0.01 Ω/m to about 0.2 Ω/m, about 0.05 Ω/m to about 0.15 Ω/m, about 0.08 to about 0.11 Ω/m, or about 0.09 to about 0.1 Ω/m.

The nonwoven sheet treated with the semiconductive composition on the first and second side thereof may have a resistance of from about 1Ω to about 30Ω or about 1Ω to about 15Ω. For example, the nonwoven sheet may have a resistance of from about 1Ω to about 15Ω, about 2Ω to about 8Ω, about 3Ω to about 7Ω, about 4Ω to about 6Ω, or about 5Ω. In another example, the nonwoven sheet may have a resistance of from about 1Ω to about 15Ω, about 3Ω to about 12Ω, or about 3.4Ω to about 11Ω.

The nonwoven sheet treated with the semiconductive composition on the first and second side thereof may have a resistivity of from about 500 Ω/sq to about 3500 Ω/sq, about 800 Ω/sq to about 3500 Ω/sq, about 700 Ω/sq to about 1300 Ω/sq, about 800 Ω/sq to about 1200 Ω/sq, about 900 Ω/sq to about 1100 Ω/sq, or about 1000 Ω/sq.

The nonwoven sheet treated with the semiconductive composition on the first and second sides thereof may have a penetration resistance or the amount of material that passes through the nonwoven sheet, of less than 10%, less than 5%, less than 4%, less than 3%, less than 2%, or less than 1%.

The nonwoven sheet treated with the semiconductive composition on the first and second sides thereof may have a penetration resistance of from about 200 N or greater to about 1200 N or greater. For example, the penetration resistance of the nonwoven sheet may be about 200 N or greater, about 300 N or greater, about 400 N or greater, about 500 N or greater, about 600 N or greater, about 700 N or greater, about 800 N or greater, or about 900 N or greater. In another example, the penetration resistance may be from about 200 N to about 1200 N, about 500 N to about 900 N, or about 600 N to about 800 N.

The following numbered paragraphs are directed to one or more exemplary variations of the subject matter of the application:
1. A semiconducting tape, comprising a nonwoven sheet and a semiconductive composition disposed on the nonwoven sheet, wherein the semiconductive composition comprises a resin or a polymer and a conductive material disposed in the resin or the polymer.
2. The semiconducting tape of paragraph 1, wherein the resin or the polymer comprises one or more of a polypropylene-based resin, a polyethylene-based resin, a copolymer of an olefin, a polyester, a polycarbonate, an acrylate polymer, a phenol resin, a urea resin, a copolymer thereof, or any combination thereof.
3. The semiconducting tape of paragraph 1 or 2, wherein the resin or the polymer comprises one or more of an acrylate polymer, an acrylic copolymer, polyethylene (PE), low density PE (LDPE), medium density PE (MDPE), high density PE (HDPE), linear low density PE (LLDPE), ultra-low density polyethylene (ULDPE), polypropylene (PP), elastomeric ethylene/propylene copolymers (EPR), ethylene/propylene/diene terpolymers (EPDM), natural rubber, butyl rubber, ethylene/vinyl acetate (EVA), ethylene/methyl acrylate (EMA), ethylene/ethyl acrylate (EEA), ethylene/butyl acrylate (EBA), ethylene/alpha-olefin thermoplastic copolymers, polystyrene, acrylonitrile/butadiene/styrene (ABS) resins, polyvinyl chloride (PVC), polyurethane (PUR), polyamides, polyethylene terephthalate (PET), polybutylene terephthalate (PBT), a copolymer thereof, or any combination thereof.
4. The semiconducting tape of any one of paragraphs 1 to 3, wherein the resin or the polymer comprises an aqueous dispersion of an acrylic copolymer.
5. The semiconducting tape of paragraph 4, wherein the acrylic copolymer is a self-crosslinking acrylic copolymer having a solid content of about 45%, a pH of about 4.0, a viscosity of less than 100 mPas at 25° C., and a glass transition temperature of about −30° C.
6. The semiconducting tape of paragraph 4 or 5, wherein the aqueous dispersion of the acrylic copolymer is surfactant stabilized.
7. The semiconducting tape of any one of paragraphs 1 to 6, wherein the conductive material comprises metallic conductive particles, carbon black, graphite, graphene, carbon nanotubes, or any combination thereof.
8. The semiconducting tape of paragraph 7, wherein the conductive material comprises carbon black.
9. The semiconducting tape of any one of paragraphs 1 to 8, wherein the semiconductive composition further comprises a crosslinking agent.
10. A semiconducting tape, comprising: a nonwoven sheet comprising a first plurality of fibers and a second plurality of fibers, wherein the first plurality of fibers is different than the second plurality of fibers; and a semiconductive composition disposed on the nonwoven sheet.
11. The semiconducting tape of paragraph 10, wherein the melting point or the glass transition temperature of the second plurality of fibers is relatively lower than the melting point or the glass transition temperature of the first plurality of fibers.
12. The semiconducting tape of paragraph 10 or 11, wherein the nonwoven sheet comprises the first plurality of fibers and the second plurality of fibers heated and pressed into a single layer.
13. The semiconducting tape of any one of paragraphs 10 to 12, wherein the first plurality of fibers and the second plurality of fibers comprises polyester fibers having an average single fiber fineness of from about 0.5 decitex (dtex) to about 9 dtex.
14. The semiconducting tape of any one of paragraphs 10 to 13, wherein a weight ratio of the first plurality of fibers to the second plurality of fibers is from about 1:5 to about 5:1.
15. A semiconducting tape, comprising a nonwoven sheet and a semiconductive composition disposed on the nonwoven sheet, wherein the semiconducting tape comprises a penetration resistance of less than 5% or a penetration resistance of about 400 Newtons (N) or greater.
16. The semiconducting tape of any one of paragraphs 1 to 15, wherein the nonwoven sheet comprises an air permeability, according to ASTM D737, of from about 0.5 cc/cm²/sec to about 7 cc/cm²/sec.
17. The semiconducting tape of any one of paragraphs 1 to 16, wherein the nonwoven sheet comprises an average pore size of from about 5 μm to about 16 μm.
18. The semiconducting tape of any one of paragraphs 1 to 17, wherein the nonwoven sheet comprises one or more of: a weight, according to ISO 536 standards, of from about 50 g/m² to about 70 g/m²; a thickness, according to ISO 534 standards, of from about 50 μm to about 120 μm; a tensile strength, according to WSP 110.4, of mini 8 200 cN/15 mm or mini 3 600 cN/15 mm; a breaking strength true warp, as measured according to ASTM D1000, of from about 30 N/cm to about 90 N/cm; an elongation true warp, as measured according to ASTM D1000, of from about 5% to about 40%; a breaking strength weft, as measured according to ASTM D1000, of from about 15 N/cm to about 50 N/cm; and an elongation weft, as measured according to ASTM D1000, of from about 5% to about 40%.
19. The semiconducting tape of any one of paragraphs 1 to 18, wherein the nonwoven sheet further comprises a casting solution disposed on a portion thereof, wherein the casting solution comprises a polysulfone.
20. The semiconducting tape of any one of paragraphs 1 to 19, further comprising a flame retardant material.
21. The semiconducting tape of any one of paragraphs 1 to 20, wherein the semiconducting tape has a resistance of from about 1 ohm to about 30 ohm.
22. The semiconducting tape of any one of paragraphs 1 to 21, wherein the semiconducting tape comprises a volume resistivity of from about 1 ohm-cm to about 100 ohm-cm.
23. A conductor assembly, comprising: a conductor core; an insulation layer disposed radially outward of the conductor core; an outer sheath disposed radially outward of the insulation layer; and the semiconducting tape of any one of paragraphs 1 to 22, wherein the semiconducting tape is disposed about the conductor core, the insulation layer, or a combination thereof.

### EXAMPLES

The examples and other implementations described herein are exemplary and not intended to be limiting in describing the full scope of compositions and methods described herein. Equivalent changes, modifications, and variations of specific implementations, materials, compositions, and methods may be made within the scope of the implementations or embodiments described herein, with substantially similar results.

### Example 1

Exemplary semiconducting tapes were prepared from nonwoven sheets and semiconductive compositions according to the implementations described herein. The respective penetration resistance of each of the exemplary semiconducting tapes was evaluated and compared to conventional semiconducting tapes prepared from woven sheets. It should be appreciated that woven sheets are generally accepted as having a relatively higher penetration resistance as compared to a nonwoven sheet due in part to the relatively lower permeability and/or relatively higher tensile strength, as compared to nonwoven sheets.

The nonwoven sheets utilized included polyethylene terephthalate (PET) fibers where a first plurality or portion of the PET fibers included PET fibers having a relatively lower melting point and glass transition temperature than the second plurality or portion of the PET fibers. The semiconductive composition utilized included an aqueous dispersion of an acrylic copolymer and a conductive material. Particularly, the semiconductive composition included the conductive material and a self-crosslinking acrylic copolymer dispersion that was surfactant stabilized, and had a solid content of about 45%, a pH of about 4.0, a viscosity of less than 100 mPas at 25° C., and a glass transition temperature (DSC) (Tg) of about −30° C. To prepare the exemplary semiconducting tapes, the nonwoven sheet was coated on one or both sides with the semiconductive composition. The conventional semiconducting tape including the woven sheet was utilized as received without modification.

To evaluate the penetration resistance, each of the exemplary semiconducting tapes and the conventional semiconducting tapes was placed on a wire mesh (40×40 stainless steel wire mesh) and a polyethylene polymer sheet was disposed on the exemplary and conventional semiconducting tapes. Heat and pressure was then applied to the polyethylene polymer sheet in a direction towards the wire mesh. The amount of force (Newtons) and the temperature was varied to evaluate the penetration resistance. The amount of the polyethylene passing through the semiconducting tapes and the wire mesh was observed. The amount of force and the temperature applied to the polyethylene sheet when the polyethylene penetrated through the semiconducting tapes was also observed.

It was surprisingly and unexpectedly discovered that the semiconducting tapes prepared from the nonwoven sheets and the semiconductive compositions according to the implementations described herein exhibited penetration resistance significantly greater than or comparable/parity to the conventional semiconducting tape prepared from the woven sheets. The results were surprising and unexpected as woven sheets are generally accepted as having a relatively higher penetration resistance as compared to a nonwoven sheet due in part to the relatively lower permeability and/or relatively higher tensile strength, as compared to nonwoven sheets. The surprising and unexpected results in the penetration resistance were observed for semiconducting tapes where the nonwoven sheet was coated on one or both sides thereof.

While the devices, systems, and methods have been described in detail herein in accordance with certain preferred implementations thereof, many modifications and changes therein may be effected by those skilled in the art. Accordingly, the foregoing description should not be construed to be limited thereby but should be construed to include such aforementioned obvious variations and be limited only by the spirit and scope of the following claims.

What is claimed is:

1. A semiconducting tape, comprising:
a nonwoven sheet and a semiconductive composition disposed on the nonwoven sheet;
wherein the semiconductive composition comprises a resin or a polymer and a conductive material disposed in the resin or the polymer.

2. The semiconducting tape of claim 1, wherein the resin or the polymer comprises one or more of a polypropylene-based resin, a polyethylene-based resin, a copolymer of an olefin, a polyester, a polycarbonate, an acrylate polymer, a phenol resin, a urea resin, a copolymer thereof, or any combination thereof.

3. The semiconducting tape of claim 1, wherein the resin or the polymer comprises one or more of an acrylate polymer, an acrylic copolymer, polyethylene (PE), low density PE (LDPE), medium density PE (MDPE), high density PE (HDPE), linear low density PE (LLDPE), ultra-low density polyethylene (ULDPE), polypropylene (PP), elastomeric ethylene/propylene copolymers (EPR), ethylene/propylene/diene terpolymers (EPDM), natural rubber, butyl rubber, ethylene/vinyl acetate (EVA), ethylene/methyl acrylate (EMA), ethylene/ethyl acrylate (EEA), ethylene/butyl acrylate (EBA), ethylene/alpha-olefin thermoplastic copolymers, polystyrene, acrylonitrile/butadiene/styrene (ABS) resins, polyvinyl chloride (PVC), polyurethane (PUR), polyamides, polyethylene terephthalate (PET), polybutylene terephthalate (PBT), a copolymer thereof, or any combination thereof.

4. The semiconducting tape of claim 1, wherein the resin or the polymer comprises an aqueous dispersion of an acrylic copolymer.

5. The semiconducting tape of claim 4, wherein the acrylic copolymer is a self-crosslinking acrylic copolymer having a solid content of about 45%, a pH of about 4.0, a viscosity of less than 100 mPas at 25° C., and a glass transition temperature of about −30° C.

6. The semiconducting tape of claim 4, wherein the aqueous dispersion of the acrylic copolymer is surfactant stabilized.

7. The semiconducting tape of claim 1, wherein the conductive material comprises metallic conductive particles, carbon black, graphite, graphene, carbon nanotubes, or any combination thereof.

8. The semiconducting tape of claim 7, wherein the conductive material comprises carbon black.

9. The semiconducting tape of claim 1, wherein the semiconductive composition further comprises a crosslinking agent.

10. A semiconducting tape, comprising:
a nonwoven sheet comprising a first plurality of fibers and a second plurality of fibers, wherein the first plurality of fibers is different than the second plurality of fibers; and
a semiconductive composition disposed on the nonwoven sheet.

11. The semiconducting tape of claim 10, wherein the melting point or the glass transition temperature of the second plurality of fibers is relatively lower than the melting point or the glass transition temperature of the first plurality of fibers.

12. The semiconducting tape of claim 10, wherein the nonwoven sheet comprises the first plurality of fibers and the second plurality of fibers heated and pressed into a single layer.

13. The semiconducting tape of claim 10, wherein the first plurality of fibers and the second plurality of fibers comprises polyester fibers having an average single fiber fineness of from about 0.5 decitex (dtex) to about 9 dtex.

14. The semiconducting tape claim 10, wherein a weight ratio of the first plurality of fibers to the second plurality of fibers is from about 1:5 to about 5:1.

15. A semiconducting tape comprising:
a nonwoven sheet and a semiconductive composition disposed on the nonwoven sheet;
wherein the semiconducting tape comprises a penetration resistance of less than 5% or a penetration resistance of about 400 Newtons (N) or greater.

16. The semiconducting tape of claim 15, wherein the nonwoven sheet comprises an air permeability, according to ASTM D737, of from about 0.5 cc/cm²/sec to about 7 cc/cm²/sec.

17. The semiconducting tape claim 15, wherein the nonwoven sheet comprises an average pore size of from about 5 μm to about 16 μm.

18. The semiconducting tape of claim 15, wherein the nonwoven sheet comprises one or more of:
a weight, according to ISO 536 standards, of from about 50 g/m² to about 100 g/m²;
a thickness, according to ISO 534 standards, of from about 50 μm to about 120 μm;
a tensile strength, according to WSP 110.4, of mini 8 200 cN/15 mm or mini 3 600 cN/15 mm;
a breaking strength true warp, as measured according to ASTM D1000, of from about 30 N/cm to about 90 N/cm;
an elongation true warp, as measured according to ASTM D1000, of from about 5% to about 40%;
a breaking strength weft, as measured according to ASTM D1000, of from about 15 N/cm to about 50 N/cm; and
an elongation weft, as measured according to ASTM D1000, of from about 5% to about 40%.

19. The semiconducting tape of claim 15, wherein the nonwoven sheet further comprises a casting solution disposed on a portion thereof, and wherein the casting solution comprises a polysulfone.

20. The semiconducting tape of claim 15, further comprising a flame retardant material.

21. The semiconducting tape of claim 15, wherein the semiconducting tape has a resistance of from about 1 ohm to about 30 ohm.

22. The semiconducting tape of claim 15, wherein the semiconducting tape comprises a volume resistivity of from about 1 ohm-cm to about 100 ohm-cm.

23. The semiconducting tape of claim 15, wherein the semiconductive composition further comprises a thickener.

24. The semiconducting tape of claim 23, wherein the thickener comprises an anionic aqueous solution of a synthetic polyacrylate.

25. The semiconducting tape of claim 23, wherein the thickener is ammonia free.

26. The semiconducting tape of claim 23, wherein the thickener comprises a total solids content of from about 9% to about 13%.

27. A conductor assembly, comprising:
a conductor core;
an insulation layer disposed radially outward of the conductor core;
an outer sheath disposed radially outward of the insulation layer; and
the semiconducting tape of claim 1, wherein the semiconducting tape is disposed about the conductor core, the insulation layer, or a combination thereof.
